(19) United States
(12) Patent Application Publication
(10) Pub. No.: US 2025/0353748 A1
(43) Pub. Date: Nov. 20, 2025

(54) Three-Dimensional Structured Ferrous Phosphate Pigment with Corrosion Early Warning Capability and Preparation Method Therefor

(71) Applicant: Lanxi Magnesium Materials Research Institute, Jinhua (CN)

(72) Inventors: Yulin Zhang, Jinhua (CN); Bin Wang, Jinhua (CN); Tong Wang, Jinhua (CN); Wei Zhong, Jinhua (CN); Kangpei Fu, Jinhua (CN)

(21) Appl. No.: 19/282,720

(22) Filed: Jul. 28, 2025

(30) Foreign Application Priority Data
Nov. 29, 2024 (CN) 202411729820.4

(51) Int. Cl. C01B 25/37

(52) U.S. Cl. CPC C01B 25/375; C01P 2004/03; C01P 2004/30; C01P 2006/60

(57) ABSTRACT

The present solution provides a preparation method for a three-dimensional structured ferrous phosphate pigment with corrosion early warning capability, including following steps: preparing a ferrous ion-containing solution for providing ferrous ions, where the ferrous ion-containing solution includes a soluble ferrous salt and a surfactant but no oxidizing ions, and the ferrous ion-containing solution is maintained in an acidic environment; preparing an initial mixed solution for providing phosphate ions and ammonium ions; and performing ultrasonic refinement, heating, and holding on the intermediate mixed solution using an auxiliary device with ultrasonic oscillation and microwave heating functions to obtain a final mixed solution; and filtering out precipitates from the final mixed solution, and then transferring the precipitates to a vacuum environment for high-temperature heating treatment to obtain a three-dimensional structured ferrous phosphate pigment with corrosion early warning capability.

### TECHNICAL FIELD

The present disclosure relates to the technical field of anti-rust inorganic pigment synthesis, in particular to a three-dimensional structured ferrous phosphate pigment with corrosion early warning capability and a preparation method therefor.

### BACKGROUND

Phosphate-based anti-rust pigments hold a significant position in the field of anti-corrosion, with a rich and diverse range of types. According to the current research status both domestically and internationally, several types have attracted significant attention, including orthophosphates, phosphites, polyphosphates, and composite phosphates.

Among these, the first-generation orthophosphate pigments, typically represented by zinc phosphate, have demonstrated remarkable performance in the field of anti-corrosion coatings. Their outstanding green and environmentally friendly properties endow them with a great advantage in the current context of increasingly stringent environmental requirements. Moreover, these pigments, being extensively used in the primer layers of traditional oil-based heavy-duty anti-corrosion coatings and novel water-based heavy-duty anti-corrosion coatings, boast excellent universality, thereby providing effective anti-rust protection for metal substrates.

However, industrial advancements have imposed higher requirements on anti-corrosion materials, revealing certain limitations in conventional zinc phosphate pigments. On the one hand, their relatively low hydrolysis degree leads to unsatisfactory passivation ability for base metals; and in practical application scenarios, when confronting aggressive ions, these pigments fail to fully play a blocking role and cannot effectively resist the corrosion damage caused by these ions to the metal. On the other hand, when aggressive ions and water molecules gradually penetrate into the epoxy coating through osmosis, the zinc phosphate locally present inside the epoxy coating will undergo a hydrolysis reaction, which will further aggravate the corrosion degree of the base metal. What is more challenging is that it is difficult to promptly detect the occurrence of corrosion based on the appearance of the epoxy coating.

Therefore, there exists an urgent need to synthesize a novel phosphate pigment that not only has the function of corrosion early warning, capable of signaling impending or initial corrosion to enable timely measures, but also provides good corrosion protection against aggressive ions, capable of effectively blocking the erosion of metal substrates by aggressive ions, thereby ensuring reliable anti-corrosion protection for metals under harsh conditions such as complex marine environments. It can be said that the successful synthesis of such a novel phosphate pigment is of great significance for the development of anti-corrosion materials that can adapt to the new generation of complex marine environments, and it will bring new development opportunities to many industries that rely on anti-corrosion materials, such as marine engineering and shipbuilding.

### SUMMARY

An object of the present disclosure is to provide a three-dimensional structured ferrous phosphate pigment with corrosion early warning capability and a preparation method therefor, so as to solve the problems that the phosphate pigments prepared by existing methods often fail to provide timely early warning for corrosion initiation and exhibit insufficient corrosion protection capability against aggressive ions.

To achieve the above object, the present technical solution provides a preparation method for a three-dimensional structured ferrous phosphate pigment with corrosion early warning capability, including following steps:
preparing a ferrous ion-containing solution for providing ferrous ions, where the ferrous ion-containing solution includes a soluble ferrous salt and a surfactant but no oxidizing ions, and the ferrous ion-containing solution is maintained in an acidic environment;
preparing an initial mixed solution for providing phosphate ions and ammonium ions, where the initial mixed solution includes phosphoric acid, a soluble phosphate, a soluble ammonium salt, and an organic solvent;
spraying the initial mixed solution in atomized form into the ferrous ion-containing solution to obtain an intermediate mixed solution, and performing ultrasonic refinement, heating, and holding on the intermediate mixed solution using an auxiliary device with ultrasonic oscillation and microwave heating functions to obtain a final mixed solution; and
filtering out precipitates from the final mixed solution, and then transferring the precipitates to a vacuum environment for high-temperature heating treatment to obtain a three-dimensional structured ferrous phosphate pigment with corrosion early warning capability.

The present solution provides a three-dimensional structured ferrous phosphate pigment with corrosion early warning capability, which is prepared according to the aforesaid preparation method.

Compared with the prior art, the present technical solution has the following features and beneficial effects:
The three-dimensional structured ferrous phosphate pigment with corrosion early warning capability prepared by the present solution demonstrates excellent corrosion early warning capability. When the pigment is doped into a water-based epoxy coating, once external oxygen and water molecules penetrate to an interface between a base metal and the epoxy coating, ferrous ions Fe²⁺ in the pigment will be oxidized to ferrous ions Fe³⁺, resulting in yellow-brown rust. This obvious color transformation is easily detectable. Users can thereby be timely aware of potential corrosion threats to the base metal protected by the coating, enabling them to take immediate actions such as anti-corrosion repairs. In this way, further corrosion deterioration can be effectively prevented, the service life of the base metal and its associated equipment and components can be extended, and simultaneously the safety risks and economic losses caused by latent corrosion can be reduced. Furthermore, the three-dimensional structure of the ferrous phosphate pigment endows it with a great advantage in anti-corrosion applications, which provides a larger specific surface area, allowing the ions Fe²⁺ and PO₄³⁻ produced by the pigment's hydrolysis to fully react with hydrolyzed ions from the base metal when the pigment is doped in the water-based epoxy coating. The generated complex precipitation can better fill micro-cracks inside the epoxy coating or form a passivation film on a surface of a base, effectively improving the compactness of the epoxy coating, playing a better blocking role against the penetration of aggressive ions, and thereby enhancing the overall anti-corrosion performance of the coating and protecting the base metal from erosion.

### BRIEF DESCRIPTION OF THE DRAWINGS

The patent or application file contains at least one drawing executed in color. Copies of this patent application publication with color drawing(s) will be provided by the Office upon request and payment of the necessary fee.

FIG. 1 is a schematic diagram of a morphology and an elemental mapping of an Echinopsis tubiflora-shaped structured ferrous phosphate pigment with corrosion early warning capability according to an example of the present disclosure.

FIG. 2 is a scanning electron microscopy image of a flower-shaped structured ferrous phosphate pigment with corrosion early warning capability according to an example of the present disclosure.

### DETAILED DESCRIPTION OF THE EMBODIMENTS

The technical solutions in the examples of the present disclosure will be clearly and completely described below in conjunction with the accompanying drawings. Obviously, the described examples are merely a part, rather than all, of the examples of the present disclosure. All other examples obtained by a person of ordinary skill in the art based on those in the present disclosure fall within the protection scope of the present disclosure.

A person skilled in the art should understand that in the present disclosure, terms such as “longitudinal,” “lateral,” “upper,” “lower,” “front,” “rear,” “left,” “right,” “vertical,” “horizontal,” “top,” “bottom,” “inner,” “outer,” etc., indicate orientation or positional relationships based on those shown in the accompanying drawings, and are only for the convenience of describing the present disclosure and simplifying the description, rather than indicating or implying that the device or element referred to must have a specific orientation, or be constructed and operated in a specific orientation, and therefore the above terms cannot be understood as a limitation on the present disclosure.

It can be understood that the term “a” or “an” should be understood as “at least one” or “one or more”, that is, in one example, the number of an element can be one, and in other examples, the number of the element can be multiple, and the term “a” or “an” cannot be understood as a limitation on the quantity.

The present solution provides a preparation method for a three-dimensional structured ferrous phosphate pigment with corrosion early warning capability, including following steps:
preparing a ferrous ion-containing solution for providing ferrous ions, where the ferrous ion-containing solution includes a soluble ferrous salt and a surfactant but no oxidizing ions, and the ferrous ion-containing solution is maintained in an acidic environment;
preparing an initial mixed solution for providing phosphate ions and ammonium ions, where the initial mixed solution includes phosphoric acid, a soluble phosphate, a soluble ammonium salt, and an organic solvent;
spraying the initial mixed solution in atomized form into the ferrous ion-containing solution to obtain an intermediate mixed solution, and performing ultrasonic refinement, heating, and holding on the intermediate mixed solution using an auxiliary device with ultrasonic oscillation and microwave heating functions to obtain a final mixed solution; and
filtering out precipitates from the final mixed solution, and then transferring the precipitates to a vacuum environment for high-temperature heating treatment to obtain a three-dimensional structured ferrous phosphate pigment with corrosion early warning capability.

The ferrous ion-containing solution prepared by the present solution uses the soluble ferrous salt to supply ferrous ions, with the surfactant enhancing dispersion in the absence of the oxidizing ions to ensure the stability of the ferrous ions; in the initial mixed solution, the phosphoric acid and the soluble ammonium salt provide phosphate ions and ammonium ions, respectively; and through atomized spraying, ultrasonic refinement, microwave heating, and holding, the two kinds of ions fully react to generate three-dimensional structured ferrous phosphate precipitates. When doped into a water-based epoxy coating, the ferrous phosphate pigment appears light blue. Upon hydrolysis, the pigment releases ferrous ions Fe²⁺ and phosphate ions PO₄³⁻, which react with hydrolyzed ions from a base metal to generate complex precipitation that fills micro-cracks or forms a passivation film, improving the compactness of the epoxy coating and blocking the penetration of aggressive ions. When external oxygen and water molecules penetrate to an interface, the ferrous ions Fe²⁺ are oxidized to ferric ions Fe⁺³, resulting in yellow-brown rust, which can serve as a corrosion early warning by virtue of this obvious color transformation, achieving effective monitoring of the corrosion status of the base metal.

By strictly ensuring the ferrous ion-containing solution is free from oxidizing ions, the present solution enables the ferrous ions to participate in the reaction with the phosphate ions in their original, unoxidized state, thus successfully preparing a pure and stable ferrous phosphate pigment. When this ferrous phosphate pigment is applied to an anti-corrosion coating system and encounters a situation where external oxygen and water molecules penetrate to the interface between the base metal and the epoxy coating, the ferrous ions, as expected, can accurately undergo an oxidation reaction where the ferrous ions Fe²⁺ are transformed into the ferric ions Fe³⁺, thereby producing obvious yellow-brown rust. This obvious color transformation is easily detectable by users, intuitively and timely indicating that the base metal protected by the coating may be under threat of corrosion, and thus enabling maintenance personnel to take immediate actions such as anti-corrosion repairs. In this way, severe damage to the base metal caused by further corrosion deterioration can be effectively prevented, the service life of the base metal and its associated equipment and components can be extended, and simultaneously the safety risks and economic losses caused by latent corrosion can be reduced.

In some examples, the soluble ferrous salt in the ferrous ion-containing solution provides ferrous ions, and the soluble ferrous salt includes one or a combination of several, in a compatible case, of ferrous chloride, ferrous sulfate, anhydrous ferrous bromide, ferrous ammonium sulfate, ferrous sulfamate, ferrous oxalate, ferrous gluconate dihydrate, and ethylenediamine ferrous sulfate tetrahydrate.

In some examples, the ferrous ion-containing solution is maintained in an acidic environment, so that the stable presence of the ferrous ions in the solution can be ensured, and the hydrolysis of the ferrous ions and the subsequent precipitation of Fe(OH)₂ can be effectively prevented.

In some examples, a pH value of the ferrous ion-containing solution ranges from 1 to 5 and is adjusted by adding a pH regulator selected from one or more of sulfuric acid, hydrochloric acid, acetic acid, and citric acid.

The surfactant in the ferrous ion-containing solution is a cationic surfactant that does not contain oxidizing ions. It can exist stably in an acidic solution, preventing any reactions with the ferrous ions Fe²⁺ in the ferrous ion-containing solution to generate precipitation. Moreover, it can effectively inhibit the growth and aggregation of ferrous phosphate crystals, thereby forming finer ferrous phosphate nanocrystals. Specifically, the cationic surfactant can effectively reduce the surface tension of the ferrous ion-containing solution, so that various components in the solution, especially the ferrous ions, can be more uniformly dispersed in the solution system. The uniformly dispersed ferrous ions can react more fully and efficiently with the phosphate ions, promoting the formation of ferrous phosphate precipitation, contributing to the formation of more uniform and regular crystal structures of ferrous phosphate, and ultimately laying a foundation for the preparation of a high-quality three-dimensional structured ferrous phosphate pigment.

In some examples, the surfactant is selected from one or more of quinolinium dodecyl bromide, a fatty amine salt, cetyltrimethylammonium chloride, and polyquaternium.

In addition, to ensure that the ferrous ions remain stable in the acidic environment of the ferrous ion-containing solution without being prematurely oxidized, the ferrous ion-containing solution of the present solution includes a complexing agent, which forms a stable complex with the ferrous ions. The formation of the complex greatly changes the chemical environment of the ferrous ions, causing a change in the distribution of their surrounding electron clouds, thereby effectively reducing the redox potential of the ferrous ions. In this way, even in the presence of potential oxidizing factors in the acidic environment, the ferrous ions can remain stable as ferrous ions by virtue of the stable complex structure formed with the complexing agent; and the formed stable complex exhibits excellent solubility and uniform dispersion in the solution, which allows the ferrous ions to be more uniformly distributed in the solution system and prevents localized areas with too high or too low concentrations.

In some examples, the complexing agent is selected from one or more of ethylenediaminetetraacetic acid, dimercaprol, sodium dimercaptopropanesulfonate, mercaptoethylamine, and thioglycolic acid.

Certainly, the ferrous ion-containing solution includes deionized water, and a mass ratio of the soluble ferrous salt to the surfactant in the ferrous ion-containing solution ranges from 1:1 to 5:2. When the ferrous ion-containing solution includes a complexing agent, a mass ratio of the soluble ferrous salt, the complexing agent, and the surfactant in the ferrous ion-containing solution ranges from 3:3:1 to 5:2:1.

Specifically, in each liter of the deionized water, a content of the soluble ferrous salt ranges from 5 g to 30 g, a content of the surfactant ranges from 2 g to 30 g (10 mL˜100 mL), a content of the complexing agent ranges from 1 g to 10 g (1 mL˜20 mL), and a content of the pH regulator ranges from 1 g to 10 g (1 mL˜20 mL).

In some examples, the ferrous ion-containing solution is placed in an auxiliary device with ultrasonic oscillation and microwave heating functions, an ultrasonic oscillation frequency is set to range from 20 kHz to 130 kHz, and a power of a microwave radiation heater ranges from 100 W to 2,000 W with a holding duration ranging from 0.1 h to 1 h. Ultrasonic oscillation at such frequency can produce a cavitation effect, promote the uniform dispersion and mixing of substances in the solution, and can also refine the ferrous phosphate particles, facilitating the formation of uniform crystal nuclei; and microwave heating within such set power range can provide suitable heat for the solution, accelerating the reaction rate and ensuring a more complete reaction between the ferrous ions and the phosphate ions. The combination of the two contributes to the preparation of a high-quality three-dimensional structured ferrous phosphate pigment with excellent performance.

In some examples, a temperature of the ferrous ion-containing solution ranges from 25° C. to 50° C.

The initial mixed solution of the present solution includes phosphate ions PO₄³⁻ and ammonium ions NH₄⁺. The phosphate ions are used to react with the ferrous ions to form a ferrous phosphate salt, and the ammonium ions are used to slow down the reaction rate between the ferrous ions and the phosphate ions, so as to promote the number of nucleation sites of ferrous phosphate crystal grains and inhibit the growth of crystal grains.

In some examples, the phosphoric acid in the initial mixed solution is selected from one or both of orthophosphoric acid and/or metaphosphoric acid. In some examples, the soluble phosphate in the initial mixed solution is selected from one or a combination of several, in a compatible case, of sodium phosphate, ammonium phosphate, potassium phosphate, sodium hydrogen phosphate, ammonium hydrogen phosphate, potassium hydrogen phosphate, sodium dihydrogen phosphate, ammonium dihydrogen phosphate, and potassium dihydrogen phosphate.

In some examples, the soluble ammonium salt is selected from one or a combination of several, in a compatible case, of ammonium carbonate, ammonium phosphate, ammonium bicarbonate, ammonium dihydrogen phosphate, ammonium sulfate, ammonium chloride, ammonium tartrate, ammonium oxalate, ammonium formate, and ammonium citrate. The addition of the ammonium salt can increase the concentration of NH₄⁺ in the initial mixed solution, slow down the reaction rate between the ferrous ions Fe²⁺ and the phosphate ions (PO₄)³⁻ in the intermediate mixed solution, so as to promote the number of nucleation sites of ferrous phosphate crystal grains and inhibit the growth of crystal grains.

In some examples, the organic solvent in the initial mixed solution is selected from one or more of ethanol, polyethylene glycol, and glycerol. By selecting a suitable organic solvent or a combination thereof, the present solution can moderately slow down the reaction rate, providing sufficient time for the ferrous phosphate crystal grains to form more nucleation sites and inhibiting excessive growth of crystal grains, thereby contributing to the preparation of a three-dimensional structured ferrous phosphate pigment.

In some examples, a pH value of the initial mixed solution ranges from 1 to 5 and is adjusted by adding a pH regulator selected from one or more of sulfuric acid, phosphoric acid, sodium dihydrogen phosphate, and potassium dihydrogen phosphate.

In some examples, the initial mixed solution is placed in a magnetically stirred water bath with a stirring speed ranging from 50 r·min⁻¹ to 1,000 r·min⁻¹, a heating power ranging from 100 W to 2,000 W, and a holding duration ranging from 0.1 h to 1 h, and the initial mixed solution is controlled at a temperature ranging from 25° C. to 50° C. This setting enables the components in the initial mixed solution to be fully and uniformly mixed. The continuous and stable stirring force generated by magnetic stirring can effectively eliminate potential localized areas with non-uniform concentrations in the solution, ensuring that components such as the phosphoric acid, the soluble ammonium salt, and the selected organic solvent are uniformly dispersed, laying a good foundation for efficient contact and reaction of substances during the subsequent mixed reaction with the ferrous ion-containing solution. A temperature between 25° C. and 50° C. also provides a suitable temperature environment for the chemical reactions in the initial mixed solution. On the one hand, this temperature range can ensure the dissociation of phosphoric acid to provide sufficient phosphate ions for the reaction with the ferrous ions to generate a ferrous phosphate salt; on the other hand, it can also maintain the soluble ammonium salt in a suitable state to exert its effect of slowing down the reaction rate between the ferrous ions and the phosphate ions, promoting the formation of nucleation sites, and inhibiting the growth of crystal grains.

In some examples, the initial mixed solution includes deionized water, and a mass ratio of the phosphoric acid, the soluble phosphate, and the organic solvent in the initial mixed solution ranges from 3:1:2 to 6:1:2. When the initial mixed solution includes a soluble ammonium salt, a mass ratio of the phosphoric acid, the soluble phosphate, the soluble ammonium salt, and the organic solvent in the initial mixed solution ranges from 3:1:1:2 to 6:1:1:2.

Specifically, in each liter of the deionized water, a content of the phosphoric acid in the initial mixed solution ranges from 0.01 L to 0.1 L, and a content of the soluble ammonium salt ranges from 5 g to 30 g; and it can also include a soluble phosphate in a range of 5 g to 30 g, an organic solvent in a range of 10 mL to 50 mL, and a pH regulator in a range of 1 g to 10 g (1 mL˜20 mL).

The initial mixed solution is sprayed in atomized form into the ferrous ion-containing solution to obtain the intermediate mixed solution, and ultrasonic refinement, heating, and holding is performed on the intermediate mixed solution using an auxiliary device with ultrasonic oscillation and microwave heating functions to obtain the final mixed solution, where an ultrasonic oscillation frequency is set to range from 20 kHz to 130 kHz, a power of a microwave radiation heater ranges from 100 W to 2,000 W, and a temperature of the intermediate mixed solution ranges from 25° C. to 50° C. with a holding duration ranging from 0.1 h to 24 h.

In some examples, a vacuum suction filtration device is used to filter out the precipitates from the final mixed solution, and then the precipitates are placed in a vacuum tube furnace for high-temperature heating treatment. Optionally, a shielding gas in the vacuum tube furnace is argon, and a heating temperature ranges from 100° C. to 200° C., to promote the decomposition of the by-product ferrous ammonium phosphate in the precipitates to form ferrous phosphate. Specifically, argon is an inert gas with stable properties and will not chemically react with the precipitates during the high-temperature heating process. It can effectively isolate air, preventing components such as oxygen in the air from contacting the precipitates and causing undesirable phenomena such as oxidation, thereby ensuring that the precipitates undergo the expected reaction path during the high-temperature treatment process. In this way, reactions such as the decomposition of the by-product ferrous ammonium phosphate are precisely facilitated to form the target product ferrous phosphate.

The finally prepared three-dimensional structured ferrous phosphate pigment with corrosion early warning capability in the present disclosure has a three-dimensional spatial structure and is loaded with ferrous ions. When doped in a water-based epoxy coating, the pigment appears light blue and demonstrates excellent hydrolysis capability. By releasing ions Fe²⁺ and (PO₄)³⁻, it can react with hydrolyzed ions from a base metal to generate complex precipitation that fills micro-cracks inside the epoxy coating or forms a passivation film on a surface of a base, effectively improving the compactness of the epoxy coating and playing a better blocking role against the penetration of aggressive ions. In addition, once external oxygen and water molecules penetrate to an interface between the base metal and the epoxy coating, the ferrous ions Fe²⁺ will be oxidized to ferrous ions Fe³⁺, resulting in yellow-brown rust, which can serve as an effective corrosion early warning mechanism.

Below are implementation examples for the preparation of three-dimensional structured ferrous phosphate pigments with corrosion early warning capability, featuring Echinopsis tubiflora-shaped and flower-shaped structures, respectively:

### Example 1

1 L of deionized water was added to a clean 10-L beaker, followed by the sequential addition of 10 g of ferrous sulfate, 2 g of quinolinium dodecyl bromide, 5 ml of ethylenediaminetetraacetic acid, and 2 ml of dilute sulfuric acid (35 wt %); an auxiliary device with ultrasonic oscillation and microwave heating functions was used to perform ultrasonic refinement and heating on the solution, with the temperature maintained at 50° C.; and the obtained solution was designated as the ferrous ion-containing solution;

1 L of deionized water was added to a clean 10-L beaker, followed by the sequential addition of 10 ml of phosphoric acid, 10 g of ammonium sulfate, and 20 ml of polyethylene glycol; a magnetically stirred water bath was used to heat the solution, with the temperature maintained at 50° C. and the stirring speed set at 200 r·min⁻¹; and the obtained solution was designated as the initial mixed solution;

The initial mixed solution was atomized and sprayed into the ferrous ion-containing solution using an air compressor-included spray device to form an intermediate mixed solution; the auxiliary device with ultrasonic oscillation and microwave heating functions was used to perform ultrasonic refinement and heating on the intermediate mixed solution, with the temperature maintained at 50° C.; and the obtained solution was designated as the final mixed solution; and

A vacuum suction filtration device was used to filter out precipitates from the final mixed solution, and then the precipitates were placed in a vacuum tube furnace for high-temperature heating treatment for 3 h, with argon as the shielding gas and the heating temperature ranging from 100° C. to 200° C. As a result, an Echinopsis tubiflora-shaped structured ferrous phosphate pigment with corrosion early warning capability was obtained.

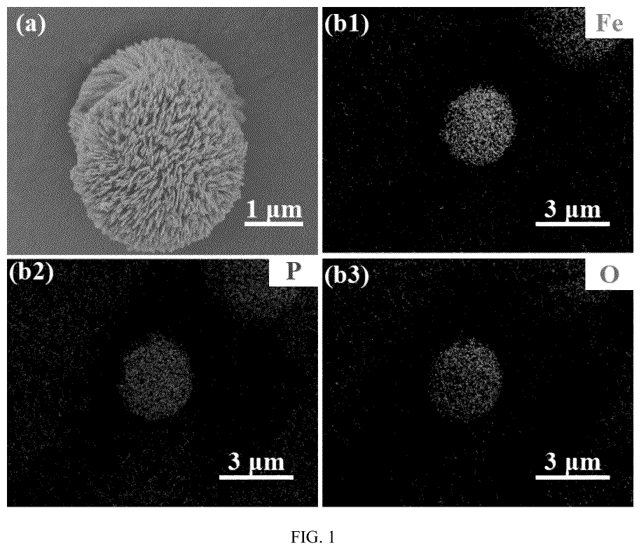

As shown in FIG. 1, FIG. 1 is a structural schematic diagram of an Echinopsis tubiflora-shaped structured ferrous phosphate pigment with corrosion early warning capability, where (a) represents a scanning electron microscopy image of the Echinopsis tubiflora-shaped structured ferrous phosphate pigment with corrosion early warning capability, and (b1), (b2), and (b3) represent energy dispersive X-ray spectroscopy (EDS) elemental mapping images. It can be seen that Example 1 of the present disclosure, using an ultrasonic oscillation and microwave heating-assisted method, can synthesize an Echinopsis tubiflora-shaped structured ferrous phosphate pigment with corrosion early warning capability. When doped in a water-based epoxy coating, the pigment appears light blue and demonstrates excellent hydrolysis capability. By releasing ions Fe²⁺ and (PO₄)³⁻, it can react with ions from a base metal to generate complex precipitation that forms a passivation film on a surface of a base, effectively improving the compactness of the epoxy coating and playing a better blocking role against the penetration of aggressive ions. In addition, once external oxygen and water molecules penetrate to an interface between the base metal and the epoxy coating, the ferrous ions Fe²⁺ will be oxidized to ferrous ions Fe³⁺, resulting in yellow-brown rust, which can serve as an effective corrosion early warning mechanism.

### Example 2

1 L of deionized water was added to a clean 10-L beaker, followed by the sequential addition of 10 g of ferrous oxalate, 5 g of cetyltrimethylammonium chloride, 5 ml of thioglycolic acid, and 5 ml of oxalic acid (670 wt %); an auxiliary device with ultrasonic oscillation and microwave heating functions was used to perform ultrasonic refinement and heating on the solution, with the temperature maintained at 25° C.; and the obtained solution was designated as the ferrous ion-containing solution;

1 L of deionized water was added to a clean 10-L beaker, followed by the sequential addition of 2 ml of phosphoric acid, 10 g of ammonium dihydrogen phosphate, 5 g of ammonium oxalate, and 30 ml of ethanol; a magnetically stirred water bath was used to heat the solution, with the temperature maintained at 25° C. and the stirring speed set at 200 r·min⁻¹; and the obtained solution was designated as the initial mixed solution;

The initial mixed solution was atomized and sprayed into the ferrous ion-containing solution using an air compressor-included spray device to form an intermediate mixed solution; the auxiliary device with ultrasonic oscillation and microwave heating functions was used to perform ultrasonic refinement and heating on the intermediate mixed solution, with the temperature maintained at 25° C.; and the obtained solution was designated as the final mixed solution; and

A vacuum suction filtration device was used to filter out precipitates from the final mixed solution, and then the precipitates were placed in a vacuum tube furnace for high-temperature heating treatment for 6 h, with argon as the shielding gas and the heating temperature ranging from 100° C. to 200° C. As a result, a flower-shaped structured ferrous phosphate pigment with corrosion early warning capability was obtained.

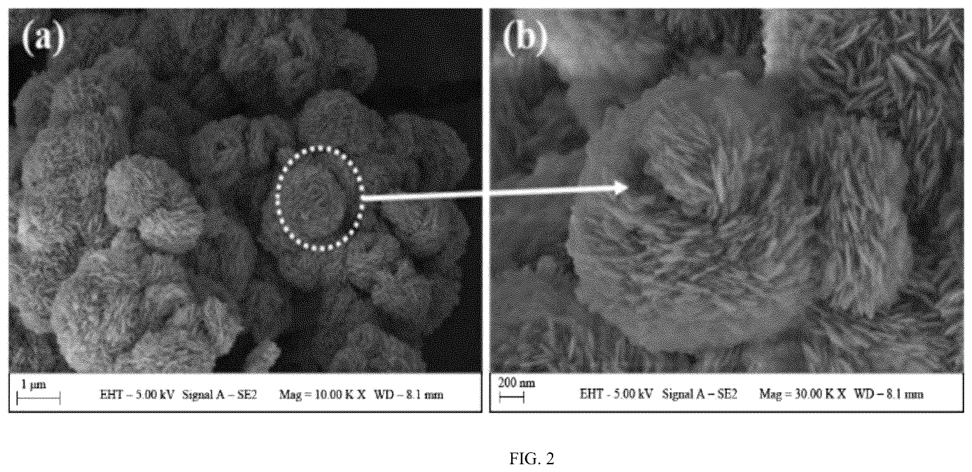

As shown in FIG. 2, FIG. 2 is a scanning electron microscopy image of a flower-shaped structured ferrous phosphate pigment with corrosion early warning capability, where (a) and (b) represent scanning electron microscopy images taken under different magnifications, respectively. Example 2 of the present disclosure, using an ultrasonic oscillation and microwave heating-assisted method, can synthesize a flower-shaped structured ferrous phosphate pigment with corrosion early warning capability. When doped in a water-based epoxy coating, the pigment appears light blue and demonstrates excellent hydrolysis capability. By releasing ions Fe²⁺ and (PO₄)³⁻, it can react with ions from a base metal to generate complex precipitation that forms a passivation film on a surface of a base, effectively improving the compactness of the epoxy coating and playing a better blocking role against the penetration of aggressive ions. In addition, once external oxygen and water molecules penetrate to an interface between the base metal and the epoxy coating, the ferrous ions Fe²⁺ will be oxidized to ferrous ions Fe³⁺, resulting in yellow-brown rust, which can serve as an effective corrosion early warning mechanism.

The present disclosure is not limited to the aforementioned preferred examples. Any person can derive other various forms of products under the inspiration of the present disclosure, but regardless of any changes in their shape or structure, any technical solution that is identical or similar to the present disclosure shall fall within the protection scope of the present disclosure.

1. A preparation method for a three-dimensional structured ferrous phosphate pigment with corrosion early warning capability, comprising following steps:
preparing a ferrous ion-containing solution for providing ferrous ions, wherein the ferrous ion-containing solution comprises a soluble ferrous salt and a surfactant but no oxidizing ions; the surfactant is selected from one or more of quinolinium dodecyl bromide, a fatty amine salt, cetyltrimethylammonium chloride, and polyquaternium, and the ferrous ion-containing solution is maintained in an acidic environment; and the ferrous ion-containing solution is placed in an auxiliary device with ultrasonic oscillation and microwave heating functions, an ultrasonic oscillation frequency is set to range from 20 kHz to 130 kHz, a power of a microwave radiation heater ranges from 100 W to 2,000 W with a holding duration ranging from 0.1 h to 1 h, and a temperature of the ferrous ion-containing solution ranges from 25° C. to 50° C.;
preparing an initial mixed solution for providing phosphate ions and ammonium ions, wherein the initial mixed solution comprises phosphoric acid, a soluble phosphate, a soluble ammonium salt, and an organic solvent; and a pH value of the initial mixed solution ranges from 1 to 5 and is adjusted by adding a pH regulator selected from one or more of sulfuric acid, phosphoric acid, sodium dihydrogen phosphate, and potassium dihydrogen phosphate;
spraying the initial mixed solution in atomized form into the ferrous ion-containing solution to obtain an intermediate mixed solution, and performing ultrasonic refinement, heating, and holding on the intermediate mixed solution using the auxiliary device to obtain a final mixed solution; and
filtering out precipitates from the final mixed solution, and then transferring the precipitates to a vacuum environment for high-temperature heating treatment to obtain a three-dimensional structured ferrous phosphate pigment with corrosion early warning capability, wherein a heating temperature ranges from 100° C. to 200° C.; wherein
when doped into a water-based epoxy coating, the ferrous phosphate pigment appears light blue; upon hydrolysis, the pigment releases ferrous ions Fe²⁺ and phosphate ions PO₄³⁻, which react with hydrolyzed ions from a base metal to generate complex precipitation that fills micro-cracks or forms a passivation film; and when external oxygen and water molecules penetrate to an interface, the ferrous ions Fe²⁺ are oxidized to ferric ions Fe³⁺, resulting in yellow-brown rust.

2. The preparation method for a three-dimensional structured ferrous phosphate pigment with corrosion early warning capability according to claim 1, wherein the soluble ferrous salt comprises one or a combination of several, in a compatible case, of ferrous chloride, ferrous sulfate, anhydrous ferrous bromide, ferrous ammonium sulfate, ferrous sulfamate, ferrous oxalate, ferrous gluconate dihydrate, and ethylenediamine ferrous sulfate tetrahydrate.

3. The preparation method for a three-dimensional structured ferrous phosphate pigment with corrosion early warning capability according to claim 1, wherein a pH value of the ferrous ion-containing solution ranges from 1 to 5 and is adjusted by adding a pH regulator selected from one or more of sulfuric acid, hydrochloric acid, acetic acid, and citric acid.

4. The preparation method for a three-dimensional structured ferrous phosphate pigment with corrosion early warning capability according to claim 1, wherein the ferrous ion-containing solution comprises a complexing agent selected from one or more of ethylenediaminetetraacetic acid, dimercaprol, sodium dimercaptopropanesulfonate, mercaptoethylamine, and thioglycolic acid.

5. The preparation method for a three-dimensional structured ferrous phosphate pigment with corrosion early warning capability according to claim 1, wherein in the initial mixed solution, the phosphoric acid is selected from one or both of orthophosphoric acid and/or metaphosphoric acid; the soluble phosphate is selected from one or a combination of several, in a compatible case, of sodium phosphate, ammonium phosphate, potassium phosphate, sodium hydrogen phosphate, ammonium hydrogen phosphate, potassium hydrogen phosphate, sodium dihydrogen phosphate, ammonium dihydrogen phosphate, and potassium dihydrogen phosphate; the soluble ammonium salt is selected from one or a combination of several, in a compatible case, of ammonium carbonate, ammonium phosphate, ammonium bicarbonate, ammonium dihydrogen phosphate, ammonium sulfate, ammonium chloride, ammonium tartrate, ammonium oxalate, ammonium formate, and ammonium citrate; and the organic solvent is selected from one or more of ethanol, polyethylene glycol, and glycerol.

6. The preparation method for a three-dimensional structured ferrous phosphate pigment with corrosion early warning capability according to claim 1, wherein a vacuum suction filtration device is used to filter out the precipitates from the final mixed solution, and then the precipitates are placed in a vacuum tube furnace for high-temperature heating treatment, with argon as a shielding gas and the heating temperature ranging from 100° C. to 200° C.
